(19) United States
(12) Patent Application Publication
(10) Pub. No.: US 2004/0205118 A1
(43) Pub. Date: Oct. 14, 2004

(54) Method and system for generalized localization of electronic documents

(76) Inventor: Allen Yu, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 09/952,616

(22) Filed: Sep. 13, 2001

(51) Int. Cl. G06F 15/16

(52) U.S. Cl. 709/203; 709/217; 715/513

(57) ABSTRACT

A system and method for programmatic localization of an electronic document sent to a user across a network. The method includes the step of determining a localization context for the user. Another step is retrieving the electronic document for the user to view. A further step is assembling the electronic document's design based on the localization context for the user.

### FIELD OF THE INVENTION

The present invention relates generally to localizing electronic content. More particularly, the present invention relates to a system for localizing electronic documents, objects and interfaces.

### BACKGROUND

In the age of increasing globalization and global competition, businesses are finding it ever more imperative to communicate with their customers around the world. Instead of communicating with customers in a single language in a homogeneous way, businesses desire to communicate in customers' local languages and in a manner that is responsive to the customers' regional cultures.

This need for customized contact is made even more challenging by the growing pervasiveness of the Internet. As the Internet becomes a significant channel of customer contact across the world, companies must meet the challenge of customizing customers' Internet experiences, even as they deliver a standard experience and uniform message.

The challenge is to avoid making separate electronic documents or web sites for the same subject matter that is localized for each region because that would be costly and difficult to maintain, but to make language or even regionally independent documents that can be easily customized for local use in a systematic, timely and cost effective manner. In this document, the processes and methods by which web sites are translated for local use and viewing will be referred to broadly as localization.

In its most generic form, localization is the process of localizing or translating an otherwise International electronic document for local consumption. The bulk of the work in such processes lies in the translation of the document text from one language to another.

Almost all methods of localization known conventionally, from Java to Microsoft based implementations, are based on the concept of string tables. While the implementation details vary and range from database to object oriented based designs, the basic idea of a string table is simple and can be illustrated succinctly via a simple database string table implementation as illustrated in FIG. 1.

In general, the “string table” of a string table localization scheme refers to the repository where the binaries of the different translated versions of strings (i.e. texts) are stored. A string is a language independent construct representing a grouping of words ranging from a few words to several paragraphs long. Referring again to FIG. 1, each string is identified by a String ID 10, and a String Description 12. Each string is also associated with multiple versions of translations. A catalogue of available languages is stored in separate table 20. A resource table 30 links the String ID with the language and stores the actual content of the string.

This basic string table scheme removes the need to “hardcode” texts that are dependent on any particular human language. Instead, the application or document makes function or procedure calls that take arguments such as the String ID and a language code. For example, to display the title of a page, instead of hard-coding the words of the title in a web page template, the application developer invokes a procedure such as:

show(string id=‘wecome_page_title’, language id=current_language)

where current_language is a variable that stores or evaluates to the current language used by the customer (i.e. French, English, etc.). This way, when a new language needs to be supported, no additional web page templates, codes, or program logic needs to be created. Instead, the only change that needs to be made is the addition of an extra version of strings in the string table repository (resource table in FIG. 1).

### SUMMARY OF THE INVENTION

In accordance with one aspect of the invention, a method is provided for programmatic localization of an electronic document. The method includes the step of determining a localization context for the user. Another step is retrieving the electronic document for the user to view. A further step is assembling the electronic document's design based on the localization context for the user.

The invention provides a method that provides localization of not just strings (or texts) but also of the layout, the formatting, and the flow of web pages and documents. The invention also includes a method where localization is processed not just with respect to language, but also with respect to other factors such as geography and culture.

In a more detailed aspect of the present invention, the system includes a localization data source and a localization data processor. The localization data source is the part of the system that stores the various data and metadata associated with the various translated elements (strings, layout, formatting, and flow) of a document to be processed. The localization data processor is the part of the system invoked to transform an otherwise generic, unlocalized (e.g. language independent) document into a localized one. In general, when the localization data processor is invoked, it first retrieves the appropriate data from the localization data source, processes the data appropriately, and then returns the final localized document.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 illustrates a prior art string table configuration for language localization;

FIG. 2 illustrates a table configuration of the present invention that provides localization of electronic documents.

FIGS. 3A-3C illustrate sample HTML code for pages with various formatting localizations.

### DETAILED DESCRIPTION

For purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

It has been recognized that it would be advantageous to develop a localization method that is more general and more powerful than the standard string based localization method described above. There are two limitations with the standard string based localization method. One, the standard method of relying on the translation of strings for localization is not powerful or general enough for applications that require the delivery of a truly customized experience, such as that required on the Internet. And two, the standard method of basing localization on language is not powerful or general enough for applications that target localization based on geography and factors other than language.

The current invention introduces improved systems and methods of localizing documents, as compared to those methods currently available. These methods are superior both in terms of flexibility and functionality. Furthermore, the methods described easily lend themselves to the localization of electronic documents distributed over the Internet such as web pages.

In a hypermedia document or web page, localization may need changes in layouts, such as the placement of the title bar, navigational bar, advertisements, etc. Changes can also be made to the formatting in the way of changes in background color, font size, graphics, etc. The flow of documents can even change in response to cultural sensitivities or political censorship.

It is noted here that in this specification, the terms web page and document are often used interchangeably. It should similarly be noted that though references may be made to specific formatting technologies (such as HTML), the localization techniques presented in the current invention are not restricted to just such technologies but can be used for other formatting technologies, visual, 3D, or otherwise.

While the string table based localization described previously is relatively straightforward and satisfies the needs of many applications, it is not really appropriate for more sophisticated applications such as Internet documents or other documents that use extensive formatting. String table based localization is satisfactory if all that is needed is the translation of the texts between documents. However, for rich hypermedia documents typical of web pages, a string table based solution is simply not sufficient to deliver a truly localized experience. A typical web page is more than just the text that populates its confines. The layout, formatting, and embellishments (such as icons and graphics), are all important elements of a web page.

For example, a page with a navigation bar on the left side might make sense for a language that reads from left to right, but such a layout does not make sense for a language that reads from right to left or even top to bottom. This shows that in addition to simply translating texts from one language to another, it is also significantly advantageous to localize the layout as well. Other elements may also need to be localized for the seamless delivery of localized web content. For instance, the font, the background color and the specific graphics of a web page are all elements that might need to be customized according to local custom and history as well. Consider the simplest of examples where one wants to display a localized banner ad. In a certain culture, one might choose to display the ad with a blue font while in another one might choose to display with a red font. The current invention allows such localizations to be done seamlessly and systematically.

Beyond the string based and format based localization mentioned above, certain pages or portions of pages need to be replaced, bypassed, or added during localization. Suppose the web site includes an address form, which prompts the user to enter the city, state, and zip code, and the application developer desires to localize the form. Even though we can translate each of the words “city,” “state,” and “zip code” to another language like Japanese, it does not make sense to present a Japanese user the same address form as described above because the concepts of state and zip codes do not translate well to Japanese addresses. In this case, a better solution is to present an entirely new address form for Japanese users, not just the same address form with translated strings. Another example of the case where pages need to be added or replaced across different locale might involve local promotions in response to local holidays. The current embodiment allows the localization of all the elements described above. In addition to allowing for string-based localization, it particularly allows for format-based, layout-based, and page flow-based localization.

Another feature of the invention is that it allows localization to be made relative to other constructs in addition to language. Some of the other constructs which localization can be based on are culture, country, and/or region of contexts. For example, consider the currency symbol. Currency, especially in the case of the European Union currency, is better localized to a region (Europe) than to any particular language (e.g. French, German, etc.). In the prior art, such localization is done unnaturally by duplicating the currency symbol within multiple languages. The current invention shows how to localize such symbols or objects with respect to multiple “contexts” to allow for more efficient and powerful localization. Such features are significant because certain documents, pages, styles, layouts, etc. are a characteristic of a region rather than a language. As another example, consider the fact that all Western European languages flow from left to right. The layout that supports a left to right type language can thus be localized to a region or a culture, which can then consists of families of languages, rather than directly to the specific languages. This invention allows any number of contexts (beyond language) to be defined and used for localization of an electronic document.

The address form example is yet another instance where localization to a context other than language makes sense. Note that one address form may be shared for all countries, for instance, in the Western European region. In that case, the address form can be localized to a region, Western Europe in this case, with the individual strings within that form localized to the specific languages of Western Europe.

The current invention also allows the different localization contexts to be nested inside each other so that a call to display a document in a certain context can be displayed with the next closest context if the localized version for the requested context does not already exist. For example, suppose one wants to display a style localized to Eastern Europe. If the Eastern European version does not exist, the European version will be displayed instead.

It's interesting to note that the current system can be integrated with an auto-detect feature to automatically invoke the localization of web pages without the user's input so that localization can be made automatically without the user's intervention. This is possible because localization can be based on certain data that can be detected about the user in an electronic request to view the web site. For example, the system can access the user profile based on cookie information to determine whether the user has set a language preference. Alternatively, the system can detect the Internet Service Provider (ISP) from which the request originates and that information can trigger the appropriate localization. In either case, the user profile or the user IP (Internet Protocol) address can also be used to determine the localization context, region or country for a user.

In addition to the regionalized auto-detect mode discussed previously, there can also be a language auto-detect mode. The system can automatically determine which primary language the user has installed on their operating system or which language is defined in a user preferences file. Then correctly configured web pages can be sent to the user based on that language. Alternately, the users ISP or IP address can be used to determine the country or language area where the request originated from and then this location is used to perform formatting, layout, and page flow localization. In any case, the language modifications are activated automatically.

In an override mode, the user can provide direct input as to which version of a web page they would like to view. This option is presented when the first page of the web site is presented. A user can then override the auto-detect for the localization context or language that has been automatically selected.

Next, an embodiment will show in detail, the fundamental features of the current invention via a database implementation. The embodiment is presented for illustrative purposes and should not be construed to restrict the scope of the current invention.

The most natural way to illustrate the main features of the current invention are through a database example, since database schemas provide a medium with which to visually convey complex relationships between data and information. The database schema that is presented below can be directly implemented on any relational database platform, with a slight augmentation of meta-data information such as dates. However, the ideas presented can also easily be ported to other technologies such object oriented, or procedurally based technologies.

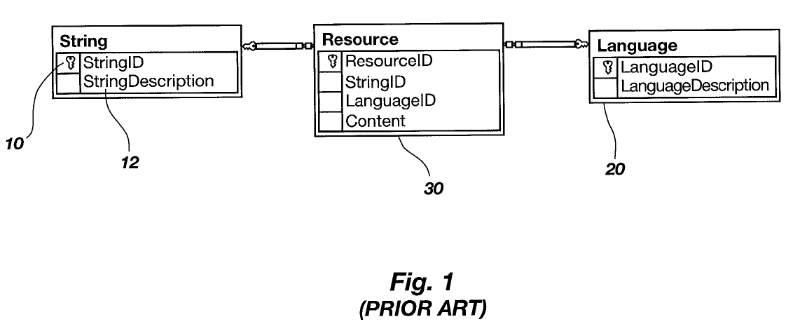

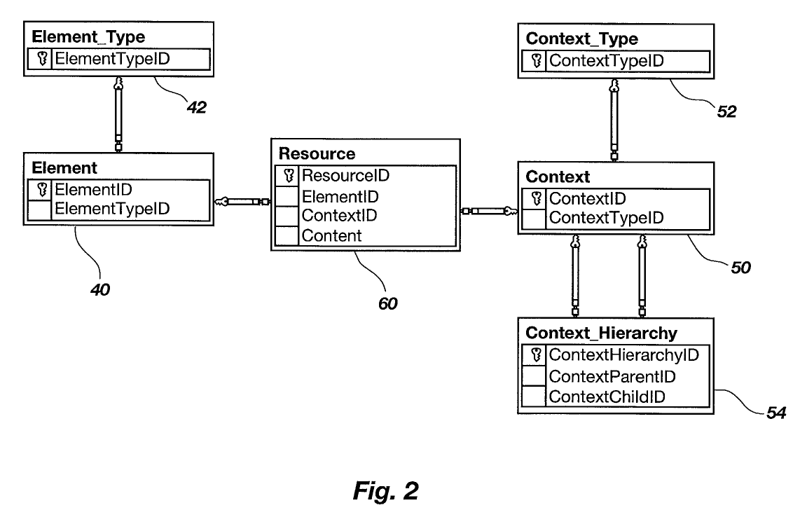

FIG. 2 shows the schema of one embodiment for the current invention. Comparing FIG. 1 (traditional string table implementation) with FIG. 2, the main differences can be summarized as follows. The string table of FIG. 1 is replaced with the Element table 40 and Element_Type table 42 in FIG. 2. The Language table of FIG. 1 is replaced with the Context table 44, Context_Type table 52, and Context_Hierarchy table 54 in FIG. 2.

### Localization Elements

The replacement of the String table in FIG. 1 with the Element table in FIG. 2 generalizes the targets that are affected in the localization process. In the string table paradigm, the only target of localization involves text string. In the current invention, in addition to translation of text strings, localization also involves the conversion of the formatting, layout, and flow of pages. The notion of the element is thus used to encompass text strings, formatting, layout, and page references. The Resource table 60 can store the content or a pointer to the content of the localized strings, layout, and page references.

Typically, the localization of formatting involves two aspects: one involves the localization of graphics and the other the localizing of formatting information such as font size and background color. The localization of simple graphics is not unlike string replacement because it can involve a simple corresponding binary replacement. The second aspect of formatting is significantly different. An example of this second aspect involves the localization of the formatting of a title text. In the string table paradigm, the hypertext markup code used to display a formatted title text might look like:

<font style=‘bold’>ShowText(‘title’,‘english’)</font>

In the new paradigm, the same code snippet would appear as

ShowStyle(‘title’,‘european’,ShowText(‘title’,‘english’))

For the function called ShowStyle, the first parameter ‘title’ is a formatting element ID; the second parameter ‘european’ is a context id; and the third parameter in this case is the result obtained from ShowText (i.e., a localized string). For the function call ShowText, the first parameter ‘title’ is a string element id, and the second parameter ‘english’ is a context id. The notion of other contexts in addition to the language context (e.g. ‘european’) will be discussed in the next section. The important idea to note here is that style, in addition to just text strings, can and should be localized. Styles and texts should be localized independently because this leads to a more natural management of the localization of styles. For example, once a ‘european’ style is created, it can be shared by all European languages rather than be recreated for each European language. Also note that a font of a given size for a language such as English might look very different than a font of the same given size in another language such as Chinese. The current system also allows a style or group of styles to be defined and associated with a specific language such as Chinese when that is needed. In general, it is much less effective and requires higher maintenance costs to store many identical versions of a resource, such as formatting, which would be required if the localization is restricted to only the language context. Note that the types of formatting need not be constrained to text or even visual formatting. The formatting can relate to displaying a border around a picture, for example, or even to the sound that is produced upon the clicking of an object on the document. Such generic formatting will be generically referred to as object formatting, with the styles referred generically as object styles.

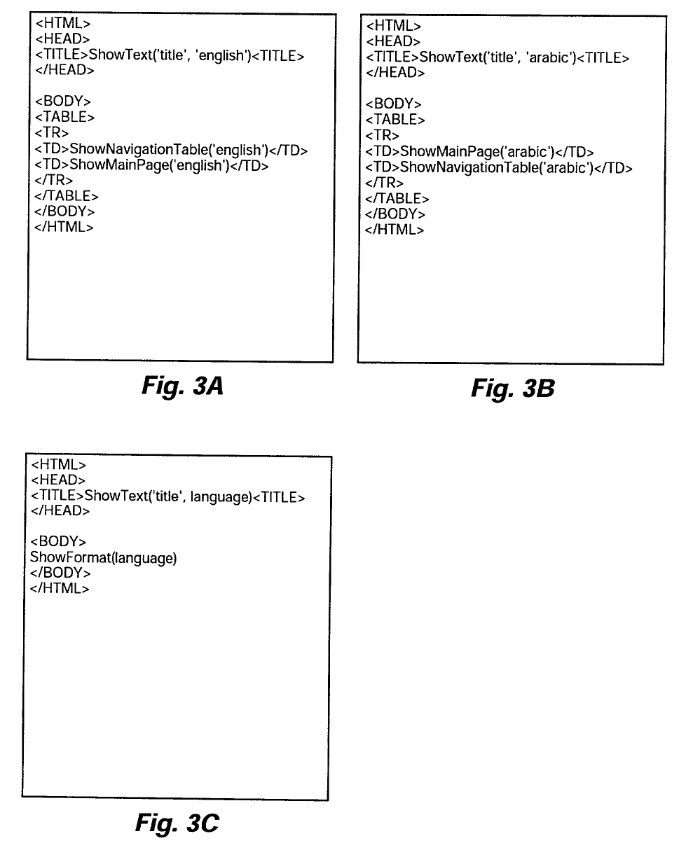

The localization of layout is another feature of the current invention. FIGS. 3A and 3B depict a page that consists of a navigation area and a main display area. With some thought, one can see that while it might make sense to display the navigation bar on the left side for a language that reads from left to right such as English, it also makes sense to display the navigation bar on the right for a language that reads from right to left such as Arabic. In the version of the page in FIG. 3A, the navigation bar is on the left side of the page. In the version FIG. 3B of the page, the navigation bar is on the right. Previously under the string table paradigm, the navigation is displayed on the left side, whether the page is displayed in English or Arabic. With the current invention, the layout of the page is localized for languages that read left to right and for languages that read in the other direction. FIG. 3C illustrates a generic version of the formatting that is controlled by the language type input to the “Show Format” procedure. This can be achieved by localizing the overall layout structure (in this case provided by the HTML <table> construct) as the code in FIG. 3C shows.

The localization of page flow is a further function of the current invention. In some important cases, entire pages need to be created or replaced for local consumption. Two examples already cited include address forms and promotions based on local holidays. The current invention allows the localization of entire pages by localizing the URL references that link between pages. The extreme case where all URL references are localized is preferably minimized, because in such a case the system is basically compiling web sites that are independently built for each local. Nevertheless, the selective localization of pages and URLs to localize page flow can be effective and powerful.

This method can also control sub-page or component flow. If only a portion of a page needs to be replaced this can also be performed. When a web page contains a frame or component that should be localized, only a portion of the web page can be redirected or substituted by this system. Referring again to FIG. 2, it is the Resource table 60 that stores either the URLs or the HTML in the flow-based localization described above.

The Element_Type table 42 defines the type of elements for localization and the Element table 40 links the element types with the Resource table 60. In one implementation, there are just four types, corresponding to text, formatting, layout, and URL localization. However, additional element types can be defined and added to the Element_Type table such as audio file localization, video localization, etc. as the application requires.

### Localization Contexts

Another major improvement of the current invention is the generalization of the language contexts for localization. The reason the Language table 20 of FIG. 1 is replaced with the Context table 50 of FIG. 2 is to more fully generalize the localization contexts under which resources are localized. In the prior art, localizations are done relative to language only. In the present invention, localization can be done relative to other contexts such as culture and region. Consider the example code from above again:

ShowStyle(‘title’,‘european’,ShowText(‘title’,‘english’))

In this case, the text is localized to the English language while the style is localized to Europe—a geographic region. The reason it can make sense to localize certain elements to geographic regions and not languages is, as mentioned above, because there may be commonality between languages in a region. Note also that the localization of the address form, discussed above, is best done relative to a regional or cultural context than relative to a language context because many cultures or regions share the same addressing format. Spain and Italy may use similar address formats, for example. In that case, they may share the same address form even though each will still have a localized version of that same form (string based localization)—i.e. in either Italian or Spanish.

Generalizing the localization context provides additional benefits for the present invention. Note the Context_Hierarchy table 54 that is associated with the Context table in FIG. 2. The Context_Hierarchy table allows contexts to be nested within one another in an unrestricted way as allowed by a self-to-self and many-to-many relationship mapping. For example, English can be categorized under the Anglo-Saxon cultural context, the Western European region context, or the North American region, and the North American region can in turn be categorized under the American Continent region context. A benefit of a hierarchical nesting of contexts is that if a localized version for a context does not exist, the next closest match can be substituted instead. So, if a style does not contain a Spanish resource, the next closest match as provided by the Context_Hierarchy—perhaps Italian—will be substituted in its place.

In conclusion, the current invention describes methods of localization that are more powerful and flexible than the string table based paradigm that currently dominates the industry. The invention introduces the concept of elements so that localization can be expanded to target not just text strings, but also formatting, layout, and page flow. The invention also introduces the idea of contexts to expand localization not just relative to languages, but to other constructs such as geographic region and cultures as well. In addition, these localization contexts can be nested to enable the powerful feature of context substitution where the approximate localization is provided and when the particular localized version of a requested element is unavailable.

It is to be understood that the above-described arrangements are only illustrative of the application for the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in implementation, form, function and manner of operation, assembly and use may be made, without departing from the principles and concepts of the invention as set forth in the claims.

What is claimed is:

1. A method for programmatic localization of an electronic document for a user, comprising the steps of:
determining a localization context for the user;
retrieving the electronic document for the user to view;
constructing the electronic document based on the localization context for the user.

2. A method as in claim 1, wherein the determining step further comprises the step of detecting the localization context automatically using an electronic request for the document from the user.

3. A method as in claim 1, wherein the step of constructing the electronic document further comprises the step of formatting the electronic document based on the localization context with which the user is affiliated.

4. A method as in claim 3, wherein the formatting step further includes the step of formatting an object style based on the localization context with which the user is affiliated.

5. A method as in claim 1, wherein the step of constructing the electronic document further comprises the step of arranging the electronic document's layout based on the localization context with which the user is affiliated.

6. A method as in claim 5, wherein the step of arranging the electronic document's layout further comprises arranging a location of navigational controls of the electronic document based on the localization context with which the user is affiliated.

7. A method for localization as in claim 1, wherein the step of constructing the electronic document further comprises the step of preparing an electronic document using a localization context that includes a plurality of nested localization contexts.

8. A method for localization as in claim 1, wherein the step of constructing the electronic document further comprises the step of preparing an electronic document using a localization context derived from the plurality of localization contexts nested within each other when the actual localization context does not exist.

9. A method for localization as in claim 1, wherein the step of constructing the electronic document further comprises the step of preparing an electronic document using a localization context derived from the plurality of localization contexts nested within each other when only an approximate localization is available.

10. A method as in claim 1, further comprising the step of displaying the assembled electronic document for the user.

11. A method for localization of an electronic document for a user, comprising the steps of:
determining a localization context with which the user is affiliated;
selecting a localized version of at least a portion of the electronic document to be
displayed to the user based on the localization context with which the user is affiliated; and
retrieving the electronic document for the user to view.

12. A method as in claim 11, wherein the determining step further comprises the step of detecting the localization context automatically using an electronic request for the document from the user.

13. A method as in claim 12, further comprising the step of using the user's Internet Service Provider or Internet Protocol address to determine the user's localization context.

14. A method as in claim 11 wherein the step of retrieving the electronic document further comprises the step of retrieving the entire electronic document to provide a localized electronic document.

15. A method for localization of electronic documents and web pages over an electronic network, comprising the steps of:
identifying a localization context for a user;
preparing an electronic document to be displayed to a user based on the localization context, wherein the localization context is contained within a hierarchy of nested localization contexts; and
transmitting an electronic document for the user to view.

16. A method for localization as in claim 15, wherein the step of preparing an electronic document further comprises the step of preparing an electronic document using the localization context that includes cultural region information.

17. A method for localization as in claim 15, wherein the step of preparing an electronic document further comprises the step of preparing an electronic document using a localization context derived from the plurality of localization contexts nested within each other when the actual localization context does not exist.

18. A method for localization as in claim 15, wherein the step of preparing an electronic document further comprises the step of preparing an electronic document using an approximate localization context derived from the plurality of localization contexts nested within each other when only an approximate localization is available.

19. A method as in claim 15, wherein the step of identifying a localization context for a user further comprises the step of detecting the localization context automatically using an electronic request for the electronic document from the user.
